(19) United States
(12) Patent Application Publication
(10) Pub. No.: US 2008/0145656 A1
(43) Pub. Date: Jun. 19, 2008

(54) Natural Fiber-Reinforced Polylactic Acid-based Resin Composition

(75) Inventor: Chang Do JUNG, Uiwang-si (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: CHEIL INDUSTRIES INC., Gumi-shi (KR)

(21) Appl. No.: 11/953,946

(22) Filed: Dec. 11, 2007

(30) Foreign Application Priority Data
Dec. 13, 2006 (KR) 2006-126722

(51) Int. Cl. D02G 3/00; C08K 7/02; C08L 1/00

(52) U.S. Cl. 428/401; 524/35

(57) ABSTRACT

Disclosed herein is a polylactic acid (PLA) based resin composition comprising (A) about 50 to about 90 parts by weight of a polylactic acid resin; (B) about 10 to about 50 parts by weight of natural fibers; and (C) about 0.01 to about 5 parts by weight of a coupling agent. The resin composition may have excellent mechanical strength, heat resistance, good moldability and color property.

### CROSS-REFERENCE TO RELATED APPLICATIONS

This non-provisional application claims priority under 35 USC Section 119 from Korean Patent Application No. 2006-126722, filed on Dec. 13, 2006, which is hereby incorporated by reference in its entirety.

### FIELD OF THE INVENTION

The present invention relates to a natural fiber-reinforced polylactic acid-based resin composition.

### BACKGROUND OF THE INVENTION

Until recently, studies of polymer materials focused more on the development of rigid polymer materials and the stability of polymer materials. With increasing awareness and concerns regarding environmental pollution from polymer waste materials worldwide, there is an increasing demand for environmentally friendly polymer materials.

Environmentally compatible polymer materials are generally divided into two categories, namely, photodegradable polymer materials and biodegradable polymer materials. Biodegradable polymer materials have a functional group degradable by a microorganism in their main chain.

Among these, aliphatic polyester polymers are of primary of interest because of their excellent processibility and the ease of control of degradability. In particular, 150 thousand tons of polylactic acid (PLA) is available throughout the global market and can be used in fields such as food packages and containers, electronic equipment cases, and so on, in which conventional nondegradable plastic has been used. Until recently, the main application of PLA resin included disposable articles that relied upon the biodegradable property of PLA, for example food containers, wrap, film, and the like. Examples of PLA resins include PLA resin produced by Natureworks Corporation of U.S.A. and Toyota Corporation of Japan.

However, conventional PLA resins lack moldability and mechanical strength as well as heat resistance. Therefore, problems occur. For example, the film products are very fragile and the molded products may be deformed when the ambient temperature rises above 60° C. due to low heat resistance.

Japanese Patent Publication Nos. 2005-220177, 2005-200517 and 2005-336220 disclose that polylactic acid based resins may have improved heat resistance and mechanical strength by introducing glass fibers thereto. However, glass fiber is not biodegradable.

Meanwhile, Japanese Patent Publication Nos. 2005-105245 and 2005-60556 disclose that kenaf may be added to a polylactic acid based resin to increase its environmentally friendly properties. However, these methods provide limited improvement in heat resistance and impact strength. Moreover, pyrolysis of lignin during molding can discolor the composition.

### SUMMARY OF THE INVENTION

The present invention includes an environmentally-friendly biodegradable polylactic acid based resin composition. The polylactic acid based resin composition of the invention can exhibit good moldability, mechanical strength and heat resistance. The polylactic acid based resin composition of the invention can also exhibit improved surface gloss and color properties.

The polylactic acid based resin composition according to the present invention comprises: (A) about 50 to about 90 parts by weight of a polylactic acid (PLA) resin, (B) about 10 to about 50 parts by weight of natural fibers and (C) about 0.01 to about 5 parts by weight of a coupling agent.

In exemplary embodiments of the invention, said PLA resin comprises about 95 to about 100% of L-lactic acid and about 0 to about 5% of D-lactic acid.

The natural fibers may be bast fibers. The natural fibers may contain at least about 95% of cellulose.

In exemplary embodiments of the invention, the natural fibers may have an average diameter of about 0.1 to about 50 μm. The length of the natural fibers may be about 1 to about 100 mm.

In certain embodiments, the natural fibers are surface treated by plasma or alkali.

In exemplary embodiments, the coupling agent may be a silane coupling agent.

The composition may further comprise additives selected from the group consisting of anti-oxidants, benzophenone- or amine-based weather resistant agents, releasing agents, colorants, UV blocking agents, fillers, nucleating agents, plasticizers, adhesion aids, adhesives and mixtures thereof.

Another aspect of the invention provides a pellet extruded from the foregoing resin composition.

Another aspect of the invention provides products molded from the resin composition. The polylactic acid based resin composition can be suitable for the production of numerous types of molded products, including vehicle parts, machine parts, electric or electronic parts, office machines and other general goods, and can be particularly useful for the production of molded products requiring heat resistance and mechanical strength.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The polylactic acid based resin composition according to the present invention comprises: (A) about 50 to about 90 parts by weight of a polylactic acid (PLA) resin, (B) about 10 to about 50 parts by weight of natural fibers and (C) about 0.01 to about 5 parts by weight of a coupling agent. Each component of the composition will be discussed below in detail.

### (A) Polylactic Acid Resin

The polylactic acid (PLA) resin is a polyester resin typically made by an ester reaction of lactic acid monomer obtained by degradation of cornstarch, and is commercially available.

The PLA resin used as the base resin in the present invention comprises L-lactic acid and D-lactic acid, for example about 95% or more of L-lactic acid. In exemplary embodiments of the present invention, the PLA resin comprises about 95 to about 100% of L-lactic acid and about 0 to about 5% of D-lactic acid.

The molecular weight or molecular weight distribution of the PLA is not particularly limited as long as the resin is moldable. In exemplary embodiments, the weight average molecular weight of the PLA is higher than about 80,000.

### (B) Natural Fibers

The natural fibers are used as a reinforcing agent in the present invention. In exemplary embodiments, the natural fibers may be bast fibers made from a flexible bast part rather than a woody part of a plant stem.

The bast fibers usable in the polymer composite of the present invention may include flax, hemp, jute, kenaf, ramie, curaua, and the like, and mixtures thereof.

Generally, cell walls of fiber cells are mainly composed of cellulose, lignin and semicellulose. When natural fibers in which lignin and semicellulose are insufficiently removed are used as natural fibers, thermal resistance and mechanical strength are not sufficiently improved. In addition, such natural fibers may discolor the molded product during the molding process due to pyrolysis of lignin.

Therefore, the natural fibers of the present invention comprise at least about 95% of cellulose, for example at least about 97% cellulose, to substantially minimize or eliminate the above-mentioned problems. If natural fibers containing less than 95% of cellulose are used, the mechanical property and heat resistance of the resin composition may be deteriorated and the molded product may be discolored.

The average length of the fibers can be about 1 to about 100 mm, for example about 3 to about 70 mm, depending on the desired mechanical strength and appearance of the resultant molded product. When the length of the fibers is less than about 1 mm, the resin composition may not provide the desired strength improvement. Fibers with a length more than about 100 mm, however, can cause problems during the molding process.

Further, the average diameter of the natural fibers can be about 0.1 to about 50 μm, for example about 1 to about 30 μm. When the diameter of the fibers exceeds about 50 μm, the natural fibers may be visible on the surface of the molded product and surface gloss may be degraded.

In exemplary embodiments of the invention, the natural fibers may be surface treated using various techniques such as plasma treatment, alkali treatment and so forth in order to improve a wetting property between natural fibers and PLA.

The natural fibers may be used in an amount of about 10 to about 50 parts by weight to improve mechanical strength and heat resistance. An amount of natural fibers of less than about 10 parts by weight may not substantially improve mechanical strength. Meanwhile, when the content is higher than about 50 parts by weight, it can be difficult or even impossible to mold the composition.

### (C) Coupling Agent

A reactant or a non-reactant coupling agent, such as a silane coupling agent, may be used as the coupling agent of the present invention.

Generally, a silane coupling agent forms an oxane bond (M-O—Si, wherein, M=Si, Ti, Al, Fe, etc.) on a surface of a mineral.

In the present invention, the silane coupling agent is added and mixed with the PLA resin along with the natural fibers, to improve the compatibility between the PLA resin and the natural fibers, and thereby also improve the mechanical strength of the composition. In contrast, poor mechanical strength is a common defect for conventional PLA based resins.

In an exemplary embodiment, the silane coupling agent may be represented by the following formula:

(RO-)ₙM-(-O X R′Y)₄₋ₙ

or

(RO-)₃Si—(—R′Y),

wherein: R and R′ are an aliphatic or aromatic thermoplastic functional group, M is a catalytic functional group such as tetravalent titanium or zirconium, X is a binder functional group such as a phosphato-, pyrophosphato-, sulfonyl-, carboxyl group and the like, Y is a thermosetting functional group, and n is in the range of about 1 to 3. In exemplary embodiments of the invention, Y can be a thermosetting functional group, such as an epoxy group, acryl group, methacryl group, mercapto group, amino group, NCO group, and the like, capable of reacting with various curatives to increase the cross-link network density or provide a UV/EB function; (RO)ₙ can be a coupling functional group such as a hydrolyzable group or a substrate reactive group with surface hydroxyl groups or protons; R′ can be a thermoplastic functional group such as aliphatic and non-polar isopropyl, butyl, octyl, isostearoyl groups; naphthenic and mildly polar dodecylbenzyl groups; or aromatic benzyl, cumyl phenyl groups which can optimize bonding as determined by polarity of the polymer or substrate; and (—R′Y) can be a hybrid functional group and can include for example mono, di or tri-organofunctional hybrid titanates, such as a titanate containing 1-mole of an aliphatic isostearoyl ligand (which can function as a thermoplastic functional group) and 2-moles of acryl ligands (which can function as a thermosetting functional group).

In exemplary embodiments of the invention, a silane coupling agent having a terminal epoxy group may be used. Examples of the silane coupling agent may include, but are not limited thereto, 3-glycidoxypropyl trimethoxy silane, 3-glycidoxy propylmethyl dimethoxysilane, 2-(3,4-epoxycyclohexyl)ethyltrimethoxysilane, 3-methacryloxy propyl trimethoxy silane and the like. The coupling agent may be used alone or in combination of two or more.

The coupling agent may be used in an amount of about 0.01 to about 5 parts by weight, for example about 0.1 to about 3 parts by weight, based on 100 parts by weight of (A)+(B). If the amount is less than about 0.01 parts by weight, it is difficult to improve mechanical strength. When the amount exceeds about 5 parts by weight, the viscosity in the melt extruder significantly rises, which can negatively affect molding performance.

Other additives may be contained in the resin composition of the present invention. The additives may include phenol type antioxidants, phosphide type antioxidants, thioether type antioxidants or amine type antioxidants, benzophenone type weather resistant agents or amine type weather resistant agents, releasing agents, colorants, UV blocking agent, fillers, nucleating agent, plasticizers, adhesion aids, adhesives and mixtures thereof.

Fluoro-containing polymers, silicon oil, metal salts of stearic acid, metal salts of montanic acid, montanic acid ester wax or polyethylene wax may be used as a releasing agent. Dyes or pigments may be used as a coloring agent.

Titanium dioxide or carbon black may be used as a UV blocking agent. Silica, clay, calcium carbonate, calcium sulfate or glass beads may be used as a filler. Talc or clay may be used as a nucleating agent.

The PLA based resin composition obtained by the present invention can be used for the production of molded products which need heat resistance and mechanical strength, for example vehicles, machine parts, electric/electronic parts, office equipment such as computers and other goods. The PLA based resin composition can be particularly useful for the production of housings for electric/electronic equipment such as televisions, computers, printers, washing machines, cassette players, audio systems, and cellular phones.

The present invention will be discussed in detail in the following examples, and the following examples are to illustrate, but not to limit the scope of the appended claims.

### EXAMPLES

(A) Polylactic Acid (PLA) Resin

PLA resin 2002D manufactured by Nature Works LLC of USA is used.

(B) Natural Fibers

The natural fibers made from hemp, having 5 mm of average length and having following average cellulose content, average diameter and surface treatment condition are used:

NF-1: natural fibers with average cellulose content of 98% and average diameter of 10 μm (no surface treatment)

NF-2: natural fibers with average cellulose content of 98% and average diameter of 10 μm (alkali surface treatment)

NF-3: natural fibers with average cellulose content of 75% and average diameter of 100 μm (no surface treatment)

(C) Coupling Agent

3-glycidoxypropyl trimethoxy silane (product name: S510) manufactured by Kenrich petrochemicals company is used.

### Example 1

90 parts by weight of the basic PLA resin, 10 parts by weight of natural fiber component (NF-1) and 0.2 parts by weight of coupling agent are mixed and the mixture is extruded at 180 to 240° C. with a conventional twin-screw extruder in pellets. The resin pellets are dried at 80° C. for 4 hours, and molded into ASTM dumbbell test specimens using a 6 oz injection molding machine at a cylinder temperature of 190° C. and a mold temperature of 80° C. with a molding cycle of 120 seconds. The results are shown in Table 1.

Test

(1) Heat distortion temperature (HDT): The heat distortion temperature is measured in accordance with ASTM D 648.

(2) Mechanical properties: Tensile strength is measured in accordance with ASTM D 638, and flexural strength and flexural modulus are determined in accordance with ASTM D 790.

(3) Color: The surface color after molding is evaluated by measuring ΔE value as follows with a Chroma Meter CR-200 by Minolta.

ΔE={square root over (ΔL²+Δa²+Δb²))}

wherein ΔL: change of brightness, Δa: change of red color and Δb: change of yellow color.

(4) Melt extrusion processibility: The melt extrusion processibility using an extruder is determined.

(O: melt extrusion is possible, X: melt extrusion is impossible.)

### Example 2

Example 2 is prepared in the same manner as in Example 1 except that the amounts of PLA resin and natural fibers are changed in accordance with Table 1 below.

### Example 3

Example 3 is prepared in the same manner as in Example 1 except that the amounts of PLA resin and natural fibers are changed in accordance with Table 1 below.

### Example 4

Example 4 is prepared in the same manner as in Example 1 except that the natural fibers are changed to NF-2 and the amounts of PLA resin and natural fibers are changed in accordance with Table 1 below.

TABLE 1

| | | | Examples | | | |
|---|---|---|---|---|---|---|
| | | | 1 | 2 | 3 | 4 |
| (A) PLA resin | | parts by weight | 90 | 80 | 70 | 80 |
| (B) Hemp | NF-1 | parts by weight | 10 | 20 | 30 | 0 |
| fibers | NF-2 | parts by weight | 0 | 0 | 0 | 20 |

| | | | | | |
|---|---|---|---|---|---|
| (C) | parts by weight | 0.2 | 0.2 | 0.2 | 0.2 |
| Coupling agent | | | | | |
| HDT | ° C. | 65 | 76 | 102 | 83 |
| Tensile strength | kgf/cm² | 770 | 1130 | 1370 | 1290 |
| Flexural strength | kgf/cm² | 1260 | 1580 | 1930 | 1640 |
| Flexural modulus | kgf/cm² | 56720 | 75250 | 98200 | 78500 |

| | | | | |
|---|---|---|---|---|
| Color (ΔE) | 2.4 | 2.7 | 3.2 | 2.6 |
| melt extrusion processibility | ◯ | ◯ | ◯ | ◯ |

### Comparative Example 1

Comparative Example 1 is prepared in the same manner as in Example 1 except that the natural fibers are not used and the amount of PLA resin is changed in accordance with Table 2 below.

### Comparative Example 2

Comparative Example 2 is prepared in the same manner as in Example 1 except that the coupling agents are not used in accordance with Table 2 below.

### Comparative Example 3

Comparative Example 3 is prepared in the same manner as in Example 1 except that the natural fibers are changed to NF-3 and the amounts of PLA resin and natural fibers are changed in accordance with Table 2 below.

### Comparative Example 4

Comparative Example 4 is prepared in the same manner as in Example 1 except that the amounts of PLA resin and natural fibers are changed in accordance with Table 2 below.

TABLE 2

| | | | Comparative Examples | | | |
|---|---|---|---|---|---|---|
| | | | 1 | 2 | 3 | 4 |
| (A) PLA resin | | parts by weight | 100 | 90 | 80 | 40 |
| (B) Hemp | NF-1 | parts by weight | 0 | 10 | 0 | 60 |
| fibers | NF-3 | parts by weight | 0 | 0 | 20 | 0 |

| | | | | | |
|---|---|---|---|---|---|
| (C) | parts by weight | 0.2 | 0 | 0.2 | 0.2 |
| Coupling agent | | | | | |
| HDT | ° C. | 55 | 55 | 61 | — |
| Tensile strength | kgf/cm² | 440 | 470 | 1080 | — |
| Flexural strength | kgf/cm² | 620 | 700 | 1330 | — |
| Flexural modulus | kgf/cm² | 24740 | 29520 | 52540 | — |

| | | | | |
|---|---|---|---|---|
| Color (ΔE) | 1.7 | 1.9 | 6.8 | — |
| Extruder melt-mixed processibility | ◯ | ◯ | ◯ | X |

As shown in Table 1, the heat resistance and the mechanical strength such as tensile strength, flexural strength and flexural modulus are all improved in the Examples 1 to 4. On the other hand, it is found that the mechanical strength such as tensile strength and so on in Comparative Example 1 in which natural fibers are not used is apparently decreased and HDT is also decreased. In Comparative Example 2 in which the coupling agent is not used, the mechanical strength and HDT are decreased, and in Comparative Example 3 using natural fibers having an average diameter above 50 μm and average content of cellulose less than 95% (NF-3), HDT and the mechanical strength is lower than those of example 4, and also there is a problem of large variation of color when molding.

The results above illustrate that using natural fibers or a coupling agent can improve mechanical strength. HDT and coupling agent or surface treatment of natural fibers can enhance compatibility with PLA resin. The results also illustrate that changing the content of cellulose or the average diameter of the fibers can influence mechanical properties and color of the molded products.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A polylactic acid (PLA) based resin composition comprising:
(A) about 50 to about 90 parts by weight of a polylactic acid resin;
(B) about 10 to about 50 parts by weight of natural fibers; and
(C) about 0.01 to about 5 parts by weight of a coupling agent.

2. The PLA resin composition of claim 1, wherein said PLA resin comprises about 95 to about 100% of L-lactic acid and about 0 to about 5% of D-lactic acid.

3. The PLA resin composition of claim 1, wherein said natural fibers are bast fibers.

4. The PLA resin composition of claim 1, wherein said natural fibers comprise at least about 95% cellulose.

5. The PLA resin composition of claim 1, wherein said natural fibers have an average diameter of about 0.1 to about 50 μm.

6. The PLA resin composition of claim 1, wherein said natural fibers have a length of about 1 to about 100 mm.

7. The PLA resin composition of claim 1, wherein said natural fibers are surface treated by plasma or alkali.

8. The PLA resin composition of claim 1, wherein said coupling agent is a silane coupling agent.

9. The PLA resin composition of claim 1, wherein said composition further comprises at least one additive selected from the group consisting of anti-oxidants, benzophenon type or amine type weather resistant agents, releasing agents, colorants, UV blocking agents, fillers, nucleating agents, plasticizers, adhesion aids, adhesives and mixtures thereof.

10. A pellet comprising a polylactic acid (PLA) based resin composition comprising (A) about 50 to about 90 parts by weight of a polylactic acid resin; (B) about 10 to about 50 parts by weight of natural fibers; and (C) about 0.01 to about 5 parts by weight of a coupling agent.

11. The pellet of claim 10, wherein said natural fibers comprise at least about 95% cellulose.

12. The pellet of claim 10, wherein said natural fibers have an average diameter of about 0.1 to about 50 μm.

13. The pellet of claim 10, wherein said natural fibers are surface treated by plasma or alkali.

14. A molded product comprising a polylactic acid (PLA) based resin composition comprising (A) about 50 to about 90 parts by weight of a polylactic acid resin; (B) about 10 to about 50 parts by weight of natural fibers; and (C) about 0.01 to about 5 parts by weight of a coupling agent.

15. The molded product of claim 14, wherein said natural fibers comprise at least about 95% cellulose.

16. The molded product of claim 14, wherein said natural fibers have an average diameter of about 0.1 to about 50 μm.

17. The molded product of claim 14, wherein said natural fibers are surface treated by plasma or alkali.

18. The molded product of claim 14, wherein said molded product is a molded electric or electronic part.

19. A molded product comprising a polylactic acid (PLA) based resin composition comprising a polylactic acid resin; natural fibers; and a coupling agent, wherein said molded product has a heat distortion temperature (HDT) as measured in accordance with ASTM D 648 of 65° C. or higher; a tensile strength as measured in accordance with ASTM D 638 of 770 kgf/cm² or higher; and a surface color ΔE after molding of 3.2 or less.
